(19) United States
(12) Patent Application Publication
(10) Pub. No.: US 2026/0266987 A1
(43) Pub. Date: Sep. 10, 2026

(54) OBJECT DETECTION DEVICE, OBJECT DETECTION METHOD, AND STORAGE MEDIUM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Junzoh TSUCHIYA, Tokyo (JP)

(21) Appl. No.: 19/554,378

(22) Filed: Mar. 2, 2026

(30) Foreign Application Priority Data
Mar. 5, 2025 (JP) 2025-034975

(51) Int. Cl. G01S 13/931; G01S 13/04

(52) U.S. Cl. CPC G01S 13/931; G01S 13/04; G01S 2013/93272

(57) ABSTRACT

An object detection device detecting an object behind a host vehicle includes a segment information acquisition unit and a segment determination unit. The segment information acquisition unit acquires segment information regarding a generation result of a segment, the segment being generated based on detection information from a ranging sensor, the segment forming a region corresponding to a candidate for a detection result of the object. The segment determination unit determines whether the segment corresponds to a towed object for the host vehicle based on the segment information. The segment determination unit performs a towing object determination based on relative positions of a first reference point for determination within the region and a second reference point for determination relative to the host vehicle, the second reference point for determination being at a position in or on the region that is different from the first reference point for determination.

### CROSS-REFERENCE TO RELATED APPLICATION

This application is based on and claims the benefit of priority from earlier Japanese Patent Application No. 2025-034975 filed Mar. 5, 2025, the description of which is incorporated herein by reference.

### BACKGROUND

### Technical Field

The present disclosure relates to an object detection device, an object detection method, and a storage medium that detect an object behind a host vehicle.

### Background Art

A driving assistance device is known that detects, using a rear lateral sensor such as a millimeter-wave radar mounted on a traveling vehicle, another vehicle traveling behind, and notifies an approach of the other vehicle. In this regard, in a case where a host vehicle is towing a towed object such as a trailer, it is conceivable that a radar wave from the rear lateral sensor may be blocked, resulting in a failure of normal operation.

### SUMMARY

In the present disclosure, provided is an object detection device detecting an object behind a host vehicle as the following. The object detection device includes at least one of (i) a circuit and (ii) a processor with a memory storing computer program code executable by the processor, the at least one of the circuit and the processor configured to implement: a segment information acquisition unit configured to acquire segment information, the segment information being information regarding a generation result of a segment, the segment being generated based on detection information from a ranging sensor, the segment forming a region corresponding to a candidate for a detection result of the object; and a segment determination unit configured to perform a towing object determination based on the segment information, the towing object determination being a determination of whether the segment corresponds to a towed object for the host vehicle, in which the segment determination unit is configured to perform the towing object determination based on relative positions of a first reference point for determination and a second reference point for determination relative to the host vehicle, the first reference point for determination being within the region, the second reference point for determination being at a position in or on the region that is different from the first reference point for determination.

### BRIEF DESCRIPTION OF THE DRAWINGS

FIG. 1 is a schematic diagram illustrating a situation where another vehicle is approaching from the right rear side of a vehicle to which the present disclosure is applied.

FIG. 2 is a block diagram illustrating a schematic device configuration of a vehicle-mounted system illustrated in FIG. 1.

FIG. 3 is a block diagram illustrating schematic functional components implemented by an object detection device illustrated in FIG. 2.

FIG. 4 is a schematic diagram illustrating an operation outline of the object detection device illustrated in FIG. 3.

FIG. 5 is a schematic diagram illustrating the operation outline of the object detection device illustrated in FIG. 3.

FIG. 6 is a schematic diagram illustrating the operation outline of the object detection device illustrated in FIG. 3.

FIG. 7 is a flowchart showing an outline of an operation example of the object detection device illustrated in FIG. 3.

FIG. 8 is a flowchart showing an outline of an operation example of the object detection device illustrated in FIG. 3.

### DETAILED DESCRIPTION OF THE PREFERRED EMBODIMENTS

Accordingly, PTL 1 discloses a rear lateral detection device that enables an accurate detection of an obstacle approaching from a rear lateral side to reduce a load on a driver, even in a case where a towed object is equipped with no sensor that performs rear detection. Specifically, according to a technology disclosed in PTL 1, a contour portion of an object (i.e., a towed object) moving with a constant distance maintained is set based on detection signals received by rear lateral radars provided on the rear left and right of a host vehicle. Then, according to such a technology, the contour portion is set as a mask area, and scan data set based on the detection signals is subjected to a mask processing of disabling an area corresponding to the mask area.

[PTL 1] JP 2017-211696 A

For this type of technology, there is a demand for more favorably reducing the occurrence of a false alarm or a false notification in a case where a towed object is present. The present disclosure is made in view of the circumstances exemplified above, or the like.

According to an aspect of the present disclosure, an object detection device (15) detecting an object behind a host vehicle (1) includes:

a segment information acquisition unit (503) configured to acquire segment information, the segment information being information regarding a generation result of a segment (Sg), the segment being generated based on detection information from a ranging sensor (11), the segment forming a region corresponding to a candidate for a detection result of the object; and

a segment determination unit (504) configured to perform a towing object determination based on the segment information, the towing object determination being a determination of whether the segment corresponds to a towed object (2) for the host vehicle, in which

the segment determination unit is configured to perform the towing object determination based on relative positions of a first reference point for determination (P1) and a second reference point for determination (P2) relative to the host vehicle, the first reference point for determination being within the region, the second reference point for determination being at a position in or on the region that is different from the first reference point for determination.

According to another aspect of the present disclosure, an object detection method of detecting an object behind a host vehicle (1), the method includes:

acquiring segment information, the segment information being information regarding a generation result of a segment (Sg), the segment being generated based on detection information from a ranging sensor (11), the segment forming a region corresponding to a candidate for a detection result of the object; and

performing a determination of whether the segment corresponds to a towed object (2) for the host vehicle based on the segment information,

the determination being based on relative positions of a first reference point for determination (P1) and a second reference point for determination (P2) relative to the host vehicle, the first reference point for determination being within the region, the second reference point for determination being at a position in or on the region that is different from the first reference point for determination.

According to still another aspect of the present disclosure, a non-transitory computer-readable storage medium storing instructions that, when executed by an object detection device (15) configured to detect an object behind a host vehicle, cause the object detection device to perform processing includes:

acquiring segment information, the segment information being information regarding a generation result of a segment (Sg), the segment being generated based on detection information from a ranging sensor (11), the segment forming a region corresponding to a candidate for a detection result of the object; and

performing a determination of whether the segment corresponds to a towed object (2) for the host vehicle based on the segment information,

the determination being based on relative positions of a first reference point for determination (P1) and a second reference point for determination (P2) relative to the host vehicle, the first reference point for determination being within the region, the second reference point for determination being at a position in or on the region that is different from the first reference point for determination.

It should be noted that a reference numeral in parentheses may be designated to each element in each section of the application document. However, such a reference numeral merely indicates an example of a correspondence relationship between that element and a specific means described in a later-described embodiment. Accordingly, the present disclosure is by no means limited by the reference numeral described above.

### Embodiment

Description will be given below on an exemplary embodiment or a specific example of the present disclosure with reference to the drawings, if necessary. It should be noted that descriptions of the embodiment(s) and modification example(s) thereof hereinbelow and description in each drawing related thereto are schematic or simplified for the purpose of a concise explanation of the content of the present disclosure, so that the content of the present disclosure is by no means limited thereby. Accordingly, the illustration in each drawing is, of course, not necessarily consistent with a specific device configuration to be actually manufactured and sold. That is to say, unless explicitly limited by the applicant during the prosecution of this application, the present disclosure should not, of course, be interpreted in a limited manner due to the description in each drawing and the corresponding description regarding a device configuration or a function or operation thereof hereinbelow.

### Vehicle-mounted System Configuration

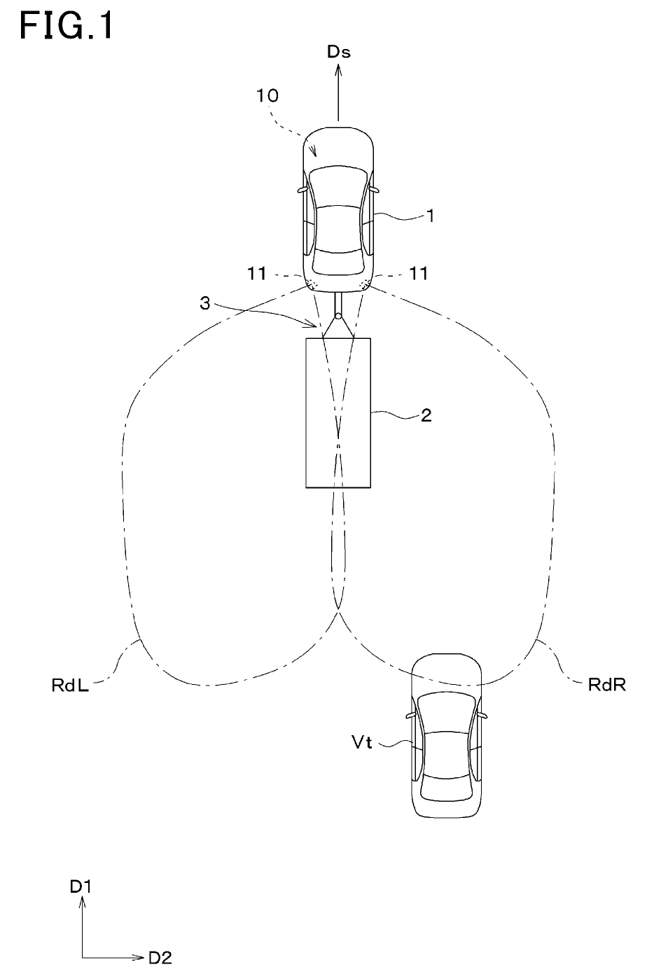

First, referring to FIG. 1, a host vehicle 1, which is an application target for the present disclosure, is a so-called includes an ordinary automobile configured to travel on a road and includes a box-shaped vehicle body. In the figure, a vehicle overall length direction D1 is a direction defining an overall length of the vehicle body of the host vehicle 1 and also a direction perpendicular to a vehicle width direction D2. The vehicle width direction D2 is a direction defining an overall width of the vehicle body of the host vehicle 1. The vehicle overall length direction D1 and the vehicle width direction D2 are perpendicular to a vehicle height direction. The vehicle height direction is a direction defining a height of the vehicle body of the host vehicle 1 and also a direction parallel with a direction of the action of gravity when the host vehicle 1 is placed on a horizontal surface in a travelable attitude.

Plane coordinates having a first axis and a second axis that are parallel with the vehicle overall length direction D1 and the vehicle width direction D2, respectively, with respect to a predetermined origin (for example, a center point of the host vehicle 1) are referred to as "D1-D2 coordinates" hereinbelow. Moreover, a plane including the first axis and the second axis is referred to as "D1-D2 plane" hereinbelow. A host vehicle travel direction Ds is a direction of travel of the host vehicle 1, that is, a direction faced by the host vehicle 1. The host vehicle travel direction Ds is parallel with the vehicle overall length direction D1 while the host vehicle 1 is traveling straight, whereas matching a tangential direction of a travel trajectory curve in the D1-D2 plane while the host vehicle 1 is traveling along a non-straight path. It should be noted that in FIG. 1 or the like, arrows indicating the vehicle overall length direction D1 and the vehicle width direction D2 are depicted at a lower left position at a distance from the host vehicle 1 in the drawing in consideration of the clarity of the drawing.

The host vehicle 1 is configured to be able to tow a towed object 2 such as a trailer. That is to say, a rear end portion of the vehicle body of the host vehicle 1 is to be coupled to the towed object 2 via a coupler 3. In a towing state in which the host vehicle 1 and the towed object 2 are coupled, the towed object 2 is coupled to the host vehicle 1 relatively rotatably along the D1-D2 plane.

A vehicle-mounted system 10 is configured to perform a variety of operations on a host vehicle 1 by being installed to the host vehicle 1. Specifically, the vehicle-mounted system 10 includes a configuration serving as a driving assistance system that performs a variety of operations of the host vehicle 1, which includes an alarm operation, based on a detection result of an object such as another vehicle Vt around the host vehicle 1 using a ranging sensor 11. The other vehicle Vt may be not only an automobile but also a two-wheeled vehicle such as a motorcycle.

In the present embodiment, description will be made below on a configuration for, out of functions of the vehicle-mounted system 10, a rear blind spot detection function. The rear blind spot detection function is a function to detect an object behind the host vehicle 1 and perform an alarm operation or the like based on the detection result.

In the present embodiment, the vehicle-mounted system 10 includes the ranging sensor 11 for detecting an object behind the host vehicle 1 or on a rear lateral side thereof and measuring a distance to the detected object as illustrated in FIG. 1. The ranging sensor 11 is provided at, within the rear end portion of the vehicle body of the host vehicle 1, each of opposite end portions in the vehicle width direction D2. In the present embodiment, the ranging sensor 11 is a so-called radar sensor, for example, a millimeter-wave sensor, configured to obtain the presence/absence of an object and a distance to the object by emitting probe waves and receiving the reflected waves of the probe waves from the object.

A detection range of the ranging sensor 11, which is a rear lateral sensor, mounted on a left rear end portion of the vehicle body of the host vehicle 1 is referred to as a left rear detection region RdL. Likewise, a detection range of the ranging sensor 11, which is a rear lateral sensor, mounted on a right rear end portion of the vehicle body of the host vehicle 1 is referred to as a right rear detection region RdR. The left rear detection region RdL and the right rear detection region RdR are bilaterally symmetrically formed. Hereinbelow, the left rear detection region RdL and the right rear detection region RdR are sometimes collectively simply referred to as "detection range."

That is to say, in the present embodiment, the vehicle-mounted system 10 is configured to detect an approaching object such as the other vehicle Vt that is present within the detection range of the ranging sensor 11. The vehicle-mounted system 10 is then configured to notify an occupant, such as a driver, of the host vehicle 1 of the approach of the approaching object from behind or the rear lateral side relative to the host vehicle 1. The term "notify" includes not only "inform" meaning a simple information provision, but "alarm" meaning a stronger alert.

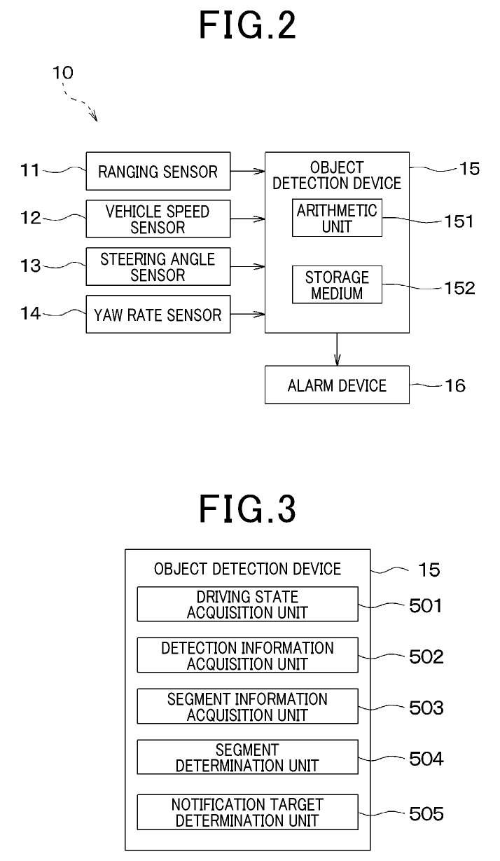

Referring to FIG. 2, the vehicle-mounted system 10 includes a vehicle speed sensor 12, a steering angle sensor 13, a yaw rate sensor 14, an object detection device 15, and an alarm device 16 in addition to the ranging sensor 11. The ranging sensor 11, the vehicle speed sensor 12, the steering angle sensor 13, and the yaw rate sensor 14 are connected to the object detection device 15 over a vehicle-mounted network so that outputs thereof are inputted to the object detection device 15. Moreover, the object detection device 15 and the alarm device 16 are connected over the vehicle-mounted network so as to be able to send and receive information or signals therebetween.

The vehicle speed sensor 12, which is a sensor that detects a traveling speed of the host vehicle 1, may be a wheel speed sensor capable of detecting a wheel rotational speed. The vehicle speed sensor 12 is configured to output a traveling speed signal corresponding to the traveling speed of the host vehicle 1 to the object detection device 15.

The steering angle sensor 13, which is a sensor that detects a steering angle of a steering wheel of the host vehicle 1, is attached to, for example, a steering rod. The steering angle sensor 13 is configured to output a steering angle signal to the object detection device 15. The steering angle signal corresponds to a change in the steering angle of the steering wheel resulting from a driver's operation. The yaw rate sensor 14, which is a sensor that detects a turning angular velocity of the host vehicle 1, is configured to output a yaw rate signal to the object detection device 15. The yaw rate signal corresponds to the turning angular velocity of the host vehicle 1.

The object detection device 15, which is a so-called object detection ECU, is configured to detect an object around the host vehicle 1 based on the outputs of the variety of sensors including the above ranging sensor 11. ECU is an abbreviation for Electronic Control Unit.

The object detection device 15 is not limited to a microcomputer, and may be implemented by hardware circuits such as logic circuits and comparison circuits.

Specifically, in the present embodiment, the object detection device 15 is configured to detect the presence and relative speed of an object, such as the other vehicle Vt, approaching the host vehicle 1 at least behind the host vehicle 1 or on the rear lateral side thereof. Moreover, the object detection device 15 is configured to output a detection result of such an object and/or a control command based thereon to each unit of the host vehicle 1, such as the alarm device 16. A configuration, function, and operation of the object detection device 15 will be described later in detail.

The alarm device 16 includes an audio output device that generates a voice or alarm sound for notification, and/or a visual output device that performs display or illumination for notification or alarm, or the like. The visual output device may be, for example, a meter panel, a head-up display device, or a light-emitting device provided on a rear-view mirror or a side mirror.

### Object Detection Device

In the present embodiment, the object detection device 15 includes a configuration serving as a vehicle-mounted computer, the configuration including at least an arithmetic unit 151 and a storage medium 152. The arithmetic unit 151 includes at least one CPU or MPU. CPU is an abbreviation for Central Processing Unit. MPU is an abbreviation for Micro Processor Unit.

The storage medium 152 includes at least one non-transitory tangible storage medium such as a ROM or a non-volatile rewritable memory. ROM is an abbreviation for Read Only Memory. The non-volatile rewritable memory is a storage device that allows information to be rewritten when power is on, whereas retaining the information in a non-rewritable manner when power is off. The non-volatile rewritable memory may be a flash ROM or a magnetic recording device.

The storage medium 152 stores a computer program and a variety of data necessary for executing the computer program, such as an initial value, a map, and a look-up table. That is to say, the object detection device 15 is configured to perform an object detection operation by the arithmetic unit 151 reading an object detection program stored in the storage medium 152 and executing it.

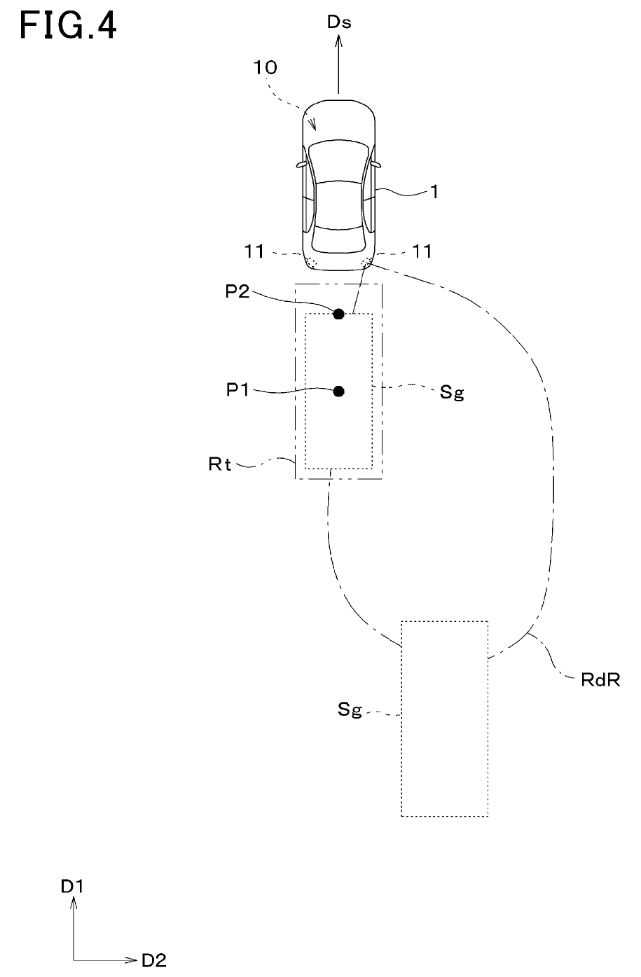

FIG. 3 illustrates an example of a functional block configuration implemented by the arithmetic unit 151 of the object detection device 15 reading the object detection program, which is a computer program, from the storage medium 152 and executing it. FIG. 4 illustrates an outline of the object detection operation to be performed by the object detection device 15 illustrated in FIG. 3. Description will be given below on the outline of the configuration of the object detection device 15 according to the present embodiment with reference to FIG. 1 to FIG. 4.

As illustrated in FIG. 3, the object detection device 15 includes, as functional components to be implemented by executing the computer program, a driving state acquisition unit 501, a detection information acquisition unit 502, a segment information acquisition unit 503, a segment determination unit 504, and a notification target determination unit 505. These functional components will be described below in detail. It should be noted that the functional components are provided merely for the convenience of explanation of functions to be achieved by the object detection device 15 and are not intended to mean that corresponding software routines and hardware units are each independently present.

The driving state acquisition unit 501 is configured to acquire a driving state of the host vehicle 1 based on outputs from the vehicle speed sensor 12, the steering angle sensor 13, and the like. The detection information acquisition unit 502 is configured to acquire detection information from the ranging sensor 11. That is to say, the detection information acquisition unit 502 is configured to receive, from the ranging sensor 11, information corresponding to object detection result provided by the ranging sensor 11 having detection regions in the left rear detection region RdL and the right rear detection region RdR, and at least temporarily store and retain a predetermined amount of the information.

The segment information acquisition unit 503 is configured to acquire segment information based on the information acquired by the driving state acquisition unit 501 and the detection information acquisition unit 502. The segment information is information regarding a generation result of a segment Sg forming a region corresponding to a candidate for a detection result of the object as illustrated in FIG. 4. That is to say, the candidate for the detection result of the object around the host vehicle 1 provided using the ranging sensor 11 is to be acquired, that is, calculated, in the form of the segment Sg as illustrated in FIG. 4.

The segment Sg is a figure such as a polygon generated based on the detection information from the ranging sensor 11. In the present embodiment, the segment Sg is a rectangle generated using one or more reflection points and estimated to encompass an external shape of an object around the host vehicle 1. The reflection point is a point corresponding to a position on an object at which the object is estimated to reflect probe waves, which is radar waves, emitted from the radar sensor.

In the present embodiment, the segment information acquisition unit 503 is configured to generate, that is, calculate, the segment Sg based on the information acquired by the driving state acquisition unit 501 and the detection information acquisition unit 502. The segment information acquisition unit 503 is also configured to generate, that is, calculate, the segment information based on the generated segment Sg. The segment information acquisition unit 503 is then configured to at least temporarily chronologically store and retain a predetermined amount of the generated information.

The segment information contains information regarding a position and a shape of the segment Sg according to the D1-D2 coordinates. Specifically, the segment information contains position information regarding an end point of an edge of the rectangle forming the segment Sg. The segment information also contains position information regarding a first reference point for determination P1 and a second reference point for determination P2 defined by the rectangle forming the segment Sg as illustrated in FIG. 4.

The first reference point for determination P1 is a point inside the rectangle forming the segment Sg, that is, on an inner side of each edge thereof. In the present embodiment, the first reference point for determination P1 is a geometrically center point of the rectangle. The second reference point for determination P2 is a point in the rectangle at a position different from the first reference point for determination P1. In the present embodiment, the second reference point for determination P2 is a midpoint of the closest edge of the rectangle to the host vehicle 1.

The segment determination unit 504 is configured to perform, based on the segment information, a towing object determination to determine whether the segment Sg corresponds to the towed object 2 for the host vehicle 1. Specifically, the segment determination unit 504 performs the towing object determination based on relative positions of the first reference point for determination P1 and the second reference point for determination P2 relative to the host vehicle 1. The towing object determination according to the present embodiment will be described below in detail.

In the present embodiment, the segment determination unit 504 performs the towing object determination in accordance with whether the first reference point for determination P1 or the second reference point for determination P2 is within a towing determination area Rt. The towing determination area Rt is a predetermined region set behind the host vehicle 1. For example, the towing determination area Rt has a width equivalent to a vehicle width of the host vehicle 1 or increased/decreased therefrom by a predetermined adjustment value and a length equivalent to a vehicle overall length of the host vehicle 1 or increased/decreased therefrom by a predetermined adjustment value. A shape and a dimension of the towing determination area Rt may be set by calibration experiment or the like.

Moreover, the segment determination unit 504 may take an initial position condition into consideration in performing the towing object determination. An initial position is a position according to the D1-D2 coordinates at the time when a certain segment Sg is first detected and tracking starts. That is to say, an initial position of the segment Sg corresponding to the towed object 2 is at a close distance directly behind the host vehicle 1. In contrast, an initial position of the segment Sg corresponding to the other vehicle Vt is a position substantially at a predetermined distance (for example, substantially at a distance equivalent to a length of the detection region) from the host vehicle 1.

Accordingly, a condition for the segment determination unit 504 determining whether the segment Sg that is a determination target corresponds to the towed object 2 may include an initial position matching condition. The initial position matching condition is a condition that the initial position of the first reference point for determination P1 or the second reference point for determination P2, that is, a position of each of them at the time when they are initially acquired, matches a predetermined initial position condition. The initial position condition is a predetermined position range behind the host vehicle 1. Such an initial position range may be the same as the towing determination area Rt, may be extended or reduced therefrom, or may be a predetermined range set independently of the towing determination area Rt.

It should be noted that information regarding the initial position is retained until the segment Sg disappears. In this regard, when the other vehicle Vt comes quite close to the rear lateral side of the host vehicle 1, mistracking may occur between the segment Sg corresponding to the other vehicle Vt and the segment Sg corresponding to the towed object 2. Consequently, even though the segment Sg actually corresponds to the towed object 2, the initial position matching condition may fail to be satisfied due to the mistracking between the segment Sg corresponding to the towed object 2 and the segment Sg corresponding to the other vehicle Vt, resulting in a failure to suppress an alarm for the segment Sg corresponding to the towed object 2.

Accordingly, as long as the segment Sg that is the determination target is determined to correspond to the towed object 2 for a certain period of time or a certain number of times of determination or more, the segment determination unit 504 maintains that determination for this segment Sg irrespective of the initial position. This makes it possible to favorably suppress the occurrence of a false alarm or a false notification attributed to mistracking.

Specifically, in response to the first reference point for determination P1 or the second reference point for determination P2 being within the towing determination area Rt, the segment determination unit 504 causes a towing determination (for example, a flag) to be ON and accumulates, as a count value (for example, a counter), a period of time during which the towing determination is ON, or the number of times the towing determination is ON. The segment determination unit 504 then compares the count value and a predetermined condition switching threshold (for example, 100) and switches a determination condition as follows in accordance with the comparison result.

That is, in a case where the count value is less than the condition switching threshold, the segment determination unit 504 determines that the segment Sg corresponds to the towed object 2 in response to a count condition and the initial position matching condition both being satisfied. The count condition is that the count value is equal to or greater than a predetermined towing determination threshold (for example, one). In contrast, in a case where the count value is equal to or greater than the condition switching threshold, the segment determination unit 504 determines that the segment Sg corresponds to the towed object 2 even though, out of the count condition and the initial position matching condition, only the count condition is satisfied.

Further, when the host vehicle 1 is in a predetermined traveling state such as when it is stopped or traveling on a curve, a detecting state of the segment Sg corresponding to the towed object 2 may be unstable. In such a case, if the above count value is decremented, suppression of an alarm for the segment Sg corresponding to the towed object 2 may become impossible.

Accordingly, even though the above towing determination is off, the segment determination unit 504 prohibits decrementing the count value as long as the driving state of the host vehicle 1 satisfies a predetermined decrement prohibition condition. The decrement prohibition condition typically includes, without limitation, for example, the host vehicle 1 being stopped or traveling on a curve (for example, R of less than 1000 m). This makes it possible to favorably suppress the occurrence of a false alarm or a false notification attributed to the driving state of the host vehicle 1.

The notification target determination unit 505 is configured to determine whether a notification target is present based on the determination result of the segment determination unit 504. The notification target is an object approaching the rear lateral side of the host vehicle 1 and for which a notification or an alarm should be issued to an occupant of the host vehicle 1, and is typically the other vehicle Vt approaching from behind or the rear lateral side of the host vehicle 1. That is to say, the notification target determination unit 505 sets the segment Sg as the notification target in a case where the segment Sg is the other vehicle Vt of this type, whereas excluding the segment Sg from the notification target in a case where the segment Sg corresponds to the towed object 2 for the host vehicle 1.

### Operation Outline

Description will be given below on an outline of an operation of a device configuration according to the present embodiment as well as the device configuration and effects produced by a method and a program performed thereby. It should be noted that in the following description, the components of the object detection device 15 according to the present embodiment and an object detection method and an object detection program performed thereby are collectively referred to as "the present embodiment."

The ranging sensor 11, which is provided at a rear end corner of the vehicle body of the host vehicle 1, detects objects behind and on the rear lateral side of the host vehicle 1. The vehicle speed sensor 12, the steering angle sensor 13, and the yaw rate sensor 14 detect the driving state of the host vehicle 1. The object detection device 15 detects whether a notification target is present based on detection information regarding an object from the ranging sensor 11 and detecting results of the driving state of the host vehicle 1 provided by the vehicle speed sensor 12 and the like. Then, in response to the presence of a notification target, the object detection device 15 causes the alarm device 16 to notify an occupant of the host vehicle, accordingly. Moreover, in response to the notification target reaching a predetermined alarm region after the notification, the object detection device 15 issues an alarm using an alarm sound or the like.

Incidentally, there is a case where the host vehicle 1 may tow the towed object 2 behind the host vehicle 1 as illustrated in FIG. 1. In this case, the segment Sg detected at a close distance directly behind the host vehicle 1 is generated as illustrated in FIG. 4. Such a segment Sg is retained within a predetermined distance to the host vehicle 1 irrespective of the movement of the host vehicle 1.

In this regard, the object detection device 15 needs to exclude such a segment Sg from the notification target. It is thus required to accurately determine whether the segment Sg corresponds to the towed object 2.

Accordingly, in the present embodiment, the towing object determination is to be performed based on the relative positions of the first reference point for determination P1 and the second reference point for determination P2 relative to the host vehicle 1. Specifically, in the present embodiment, in a case where the first reference point for determination P1 or the second reference point for determination P2 is within the towing determination area Rt, the segment Sg is determined to correspond to the towed object 2.

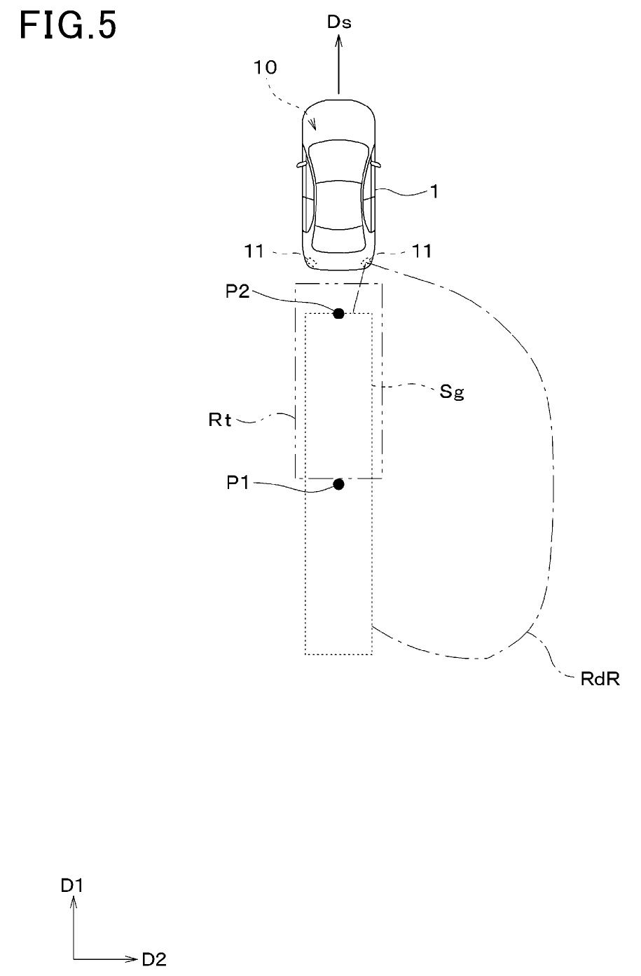

Consequently, even if the towed object 2 is an elongated trailer and thus the segment Sg is increased in length with the first reference point for determination P1, which is the center point, being outside the towing determination area Rt as illustrated in FIG. 5, the second reference point for determination P2 on the near side is within the towing determination area Rt. Therefore, it is possible to favorably perform the towing object determination irrespective of the dimension of the towed object 2.

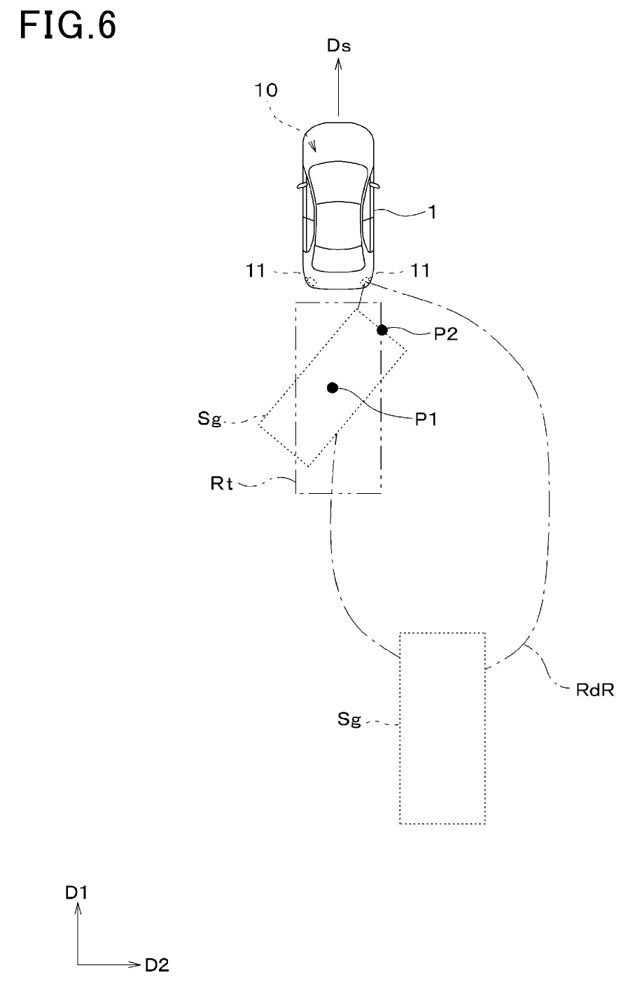

Moreover, even if the towed object 2 is relatively rotated relative to the host vehicle 1, causing the segment Sg to be significantly inclined with the second reference point for determination P2 on the near side being outside the towing determination area Rt as illustrated in FIG. 6, the first reference point for determination P1, which is the center point, is within the towing determination area Rt. Therefore, it is possible to favorably perform the towing object determination irrespective of the attitude of the towed object 2.

Moreover, in the present embodiment, at an initial stage of detection of the segment Sg corresponding to the towed object 2, the conditions for determining whether the segment Sg that is a determination target corresponds to the towed object 2 include the initial position matching condition. However, in the present embodiment, as long as the segment Sg is determined to correspond to the towed object 2 for the certain period of time or the certain number of times of determination or more, determination of the initial position matching condition for the segment Sg is skipped. This makes it possible to favorably suppress the occurrence of a false alarm or a false notification attributed to mistracking of the segment Sg.

Moreover, in the present embodiment, when the host vehicle 1 is in the predetermined traveling state such as when it is stopped or traveling on a curve, decrementing of the count value (for example, a counter) resulting from turning off the towing determination (for example, a flag) is prohibited. This makes it possible to favorably suppress the occurrence of a false alarm or a false notification attributed to such a traveling state.

### Operation Examples

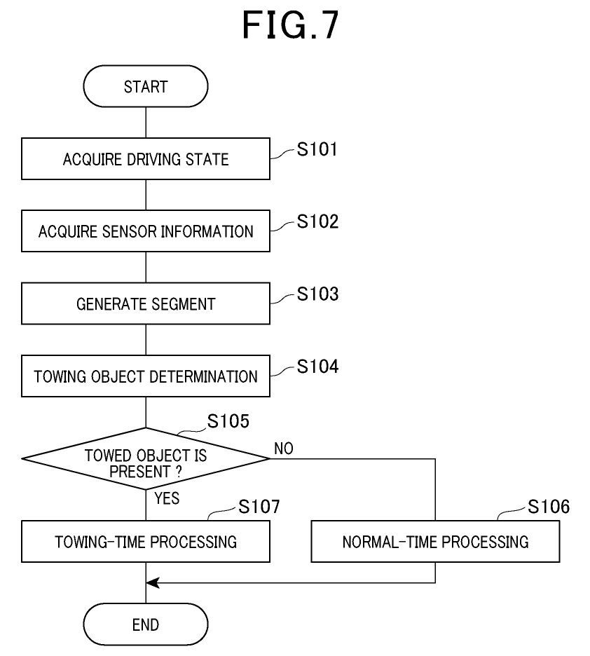

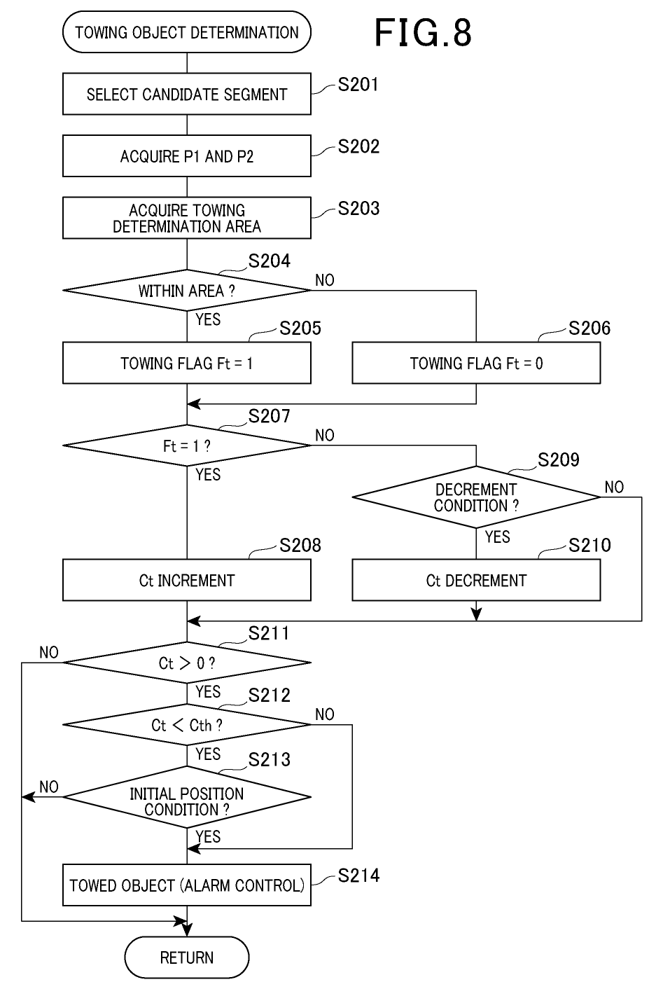

FIG. 7 illustrates a flowchart showing a routine corresponding to an object detection program, that is, a rear blind spot monitoring assistance program, according to the present embodiment. It should be noted that "S" in the flowchart in FIG. 7 is an abbreviation for "Step." The same applies to a flowchart in FIG. 8. Description will be given below on a specific example of the object detection operation according to the present embodiment with reference to the flowcharts.

The arithmetic unit 151 of the object detection device 15 executes the object detection method according to the present embodiment by reading the program according to the present embodiment from the storage medium 152 and starting it at a predetermined time interval (for example, 10 msec). When the program is started, the arithmetic unit 151 first performs processing in Step S101 to Step S104 in sequence.

In Step S101, the arithmetic unit 151 acquires the driving state of the host vehicle 1. In Step S102, the arithmetic unit 151 acquires detection information, that is, sensor information from the ranging sensor 11. In Step S103, the arithmetic unit 151 generates the segment Sg based on the driving state acquired in Step S101 and the sensor information acquired in Step S102. It should be noted that no segment Sg may be generated in Step S103 depending on the content of the detection information.

In Step S104, the arithmetic unit 151 performs the towing object determination for the segment Sg generated in Step S103. That is to say, for all the generated segments Sg, the arithmetic unit 151 performs processing related to determination of whether each segment Sg corresponds to the towed object 2 (for example, flag processing or counter processing). Then, the arithmetic unit 151 determines whether the towed object 2 is present, that is, whether the towed object 2 is coupled to the host vehicle 1, in Step S105.

In response to the absence of the towed object 2 (that is, Step S105 = NO), the arithmetic unit 151 performs the processing in Step 106 and then temporarily terminates this routine. In Step S106, the arithmetic unit 151 performs normal-time processing, that is, processing for a case where no towed object 2 is present; specifically, a processing including normal object detection operation without the assumption of the presence of the towed object 2 and a notification or the like based thereon.

In contrast, in response to the presence of the towed object 2 (that is, Step S105 = YES), the arithmetic unit 151 performs processing in Step S107 and then temporarily terminates this routine. In Step S107, the arithmetic unit 151 performs towing-time processing, that is, processing for a case where the towed object 2 is present. Specifically, the towing-time processing includes, for example, excluding the segment Sg corresponding to the towed object 2 from the notification target and/or changing an object detection condition as described in JP 2023-69937 A.

FIG. 8 illustrates, in the form of a flowchart, a content of the towing object determination in Step S104 in FIG. 7. The towing object determination illustrated in FIG. 8 is repeatedly performed for the number of times corresponding to the number of the segments Sg generated in Step S103 in FIG. 7. When the towing object determination is started, the arithmetic unit 151 first performs processing in Step S201 to Step S204 in sequence.

In Step S201, the arithmetic unit 151 selects, as a candidate segment, the segment Sg that is a current determination target. In Step S202, the arithmetic unit 151 acquires position information regarding the first reference point for determination P1 and the second reference point for determination P2 for the candidate segment. In Step S203, the arithmetic unit 151 acquires the towing determination area Rt. In Step S204, the arithmetic unit 151 determines whether the first reference point for determination P1 or the second reference point for determination P2 is within the towing determination area Rt.

In response to it being within the towing determination area Rt (that is, Step S204 = YES), the arithmetic unit 151 performs processing in Step S205. In Step S205, the arithmetic unit 151 turns on a towing determination flag Ft (that is, Ft = 1). Contrarily, in response to it being outside the towing determination area Rt (that is, Step S204 = NO), the arithmetic unit 151 performs processing in Step 206. In Step S206, the arithmetic unit 151 turns off the towing determination flag Ft (that is, Ft = 0).

After performing the flag processing in Step S205 or Step S206, the arithmetic unit 151 performs processing in Step 207. In Step S207, the arithmetic unit 151 determines whether the towing determination flag Ft is on.

The towing determination flag Ft is on (that is, Step S207 = YES), the arithmetic unit 151 performs processing in Step S208. In Step S208, the arithmetic unit 151 increments a count value counter Ct (that is, Ct(n) = Ct(n-1) + 1). The count value counter Ct is an integer of zero or greater. n indicates the ordinal number of the current processing, that is, the n-th iteration.

Contrarily, in response to the towing determination flag Ft being off (that is, Step S207 = NO), the arithmetic unit 151 performs processing in Step S209. In Step S209, the arithmetic unit 151 determines whether the driving state of the host vehicle 1 matches a decrement condition. The decrement condition is that the above decrement prohibition condition is not matched. That is to say, the arithmetic unit 151 determines whether the driving state of the host vehicle 1 matches the decrement prohibition condition.

In response to the driving state of the host vehicle 1 matching the decrement condition (that is, Step S209 = YES), the arithmetic unit 151 performs processing in Step S210. In Step S210, the arithmetic unit 151 decrements the count value counter Ct (that is, Ct(n) = Ct(n-1)-1).

After performing the counter processing in Step S208 or Step S210, the arithmetic unit 151 performs processing in Step S211. Moreover, in response to the driving state of the host vehicle 1 matching the decrement prohibition condition (that is, Step S209 = NO), the arithmetic unit 151 skips the processing in Step S210 and performs the processing in Step S211.

In Step S211, the arithmetic unit 151 determines whether the value of the count value counter Ct exceeds zero, that is, whether the value of the count value counter Ct is one or greater. The determination in Step S211 corresponds to a determination of whether the above count condition is satisfied.

In response to the value of the count value counter Ct being one or greater (that is, Step S211 = YES), the arithmetic unit 151 advances to processing in Step S212. Contrarily, in response to the value of the count value counter Ct being zero (that is, Step S211 = NO), the arithmetic unit 151 skips all the processing in Step S212 and subsequent steps, terminating the towing object determination processing for the current candidate segment.

In Step S212, the arithmetic unit 151 determines whether the value of the count value counter Ct is less than a threshold Cth. The threshold Cth corresponds to the above condition switching threshold.

In response to the value of the count value counter Ct being less than the threshold Cth (that is, Step S212 = YES), the arithmetic unit 151 advances to processing in Step S213. In Step S213, the arithmetic unit 151 determines whether the candidate segment satisfies the initial position condition. That is to say, the arithmetic unit 151 determines whether the initial position matching condition is satisfied for the candidate segment.

In response to the initial position matching condition being satisfied, (that is, Step S213 = YES), the arithmetic unit 151 performs processing in Step S214 and then terminates the towing object determination processing for the current candidate segment. In Step S214, the arithmetic unit 151 determines that the current candidate segment corresponds to the towed object 2. This suppresses an alarm for the current candidate segment.

In response to the value of the count value counter Ct being equal to or greater than the threshold Cth (that is, Step S212 = NO), the arithmetic unit 151 skips the processing in Step S213, terminating the towing object determination processing for the current candidate segment after advancing to processing in Step S214. That is to say, in response to the value of the count value counter Ct being equal to or greater than the threshold Cth, it is determined that the current candidate segment corresponds to the towed object 2 without determining whether the candidate segment satisfies the initial position condition.

In response to the initial position matching condition being not satisfied (that is, Step S213 = NO), the arithmetic unit 151 skips the processing in Step S214, terminating the towing object determination processing for the current candidate segment. In this case, it is not determined that the current candidate segment corresponds to the towed object 2.

### Modification Examples

The present disclosure is not limited to the above embodiment and specific examples. Hence, the above embodiment and the like may be modified, if necessary. Representative modification examples will be described below. In the following description on the modification examples, a difference from the above embodiment and the like will be mainly described. Moreover, the above embodiment and the like and the following modification examples may have portions that are the same as or equivalent to each other, which are designated with the same reference numeral. Thus, in the following description on the modification examples, unless a technical inconsistency arises or any particular additional explanation is provided, the description in the above embodiment and the like may be applied to a component with the same reference numeral as in the above embodiment and the like, if necessary.

The present disclosure is not limited to the specific purpose of use or device configuration described in the above embodiment. For example, the host vehicle 1 may be a so-called ordinary automobile, a large automobile, a two-wheeled vehicle, or a three-wheeled vehicle. That is to say, there is no particular limitation on the type, shape, size of the vehicle body. The same applies to the other vehicle Vt.

The ranging sensor 11 may be a LiDAR sensor, an ultrasonic sensor, or a camera sensor. LIDAR is an abbreviation for Light Detection and Ranging or Laser Imaging Detection and Ranging. The LiDAR sensor and the camera sensor may be collectively referred to as "image sensor."

The object detection device 15 may be an ECU for a driving control of the host vehicle 1. Such an ECU, which may also be referred to as a driving control ECU, may be a driving assistance ECU or an automated driving ECU. That is to say, the object detection result provided by the object detection device 15 may be used for the driving control of the host vehicle 1 as well as for the purpose of notifying or alarming the occupant.

The driving assistance ECU is an ECU configured to enable, out of the driving automation levels defined in the "SAE J3016" standard published by SAE International, Level 1 or 2. The automated driving ECU is an ECU configured to enable, out of the driving automation levels defined in that standard, any one of Levels 3 to 5. That is to say, the vehicle-mounted system 10 may be a driving assistance system or an automated driving system.

The object detection device 15 may include, in whole or in part, a digital circuit configured to enable a function or an operation as described above, such as an ASIC or an FPGA. ASIC is an abbreviation for Application Specific Integrated Circuit. FPGA is an abbreviation for Field Programmable Gate Array. That is to say, a vehicle-mounted microcomputer section and a digital circuit section may coexist in the object detection device 15.

A computer program according to the present disclosure, which allows the variety of operations, procedures, or processing described in the above embodiment to be performed, may be downloaded onto a non-volatile rewritable memory or upgraded through V2X communication using a communication device. V2X is an abbreviation for Vehicle to X. Alternatively, the computer program may be downloaded or upgraded via terminal equipment installed at a manufacturing plant, maintenance facility, dealership, or the like of the host vehicle 1. The non-volatile rewritable memory, in which the computer program is to be stored, is not limited to a semiconductor memory such as a flash memory and may be an optical or magnetic recording medium or the like.

As can be seen from the above, the above functional components and processing may be implemented by a dedicated computer provided by configuring a memory and a processor programmed to perform one or a plurality of functions embodied by the computer program. Alternatively, the above functional components and processing may be implemented by a dedicated computer provided by configuring a processor including one or more dedicated hardware logic circuits. Alternatively, the above functional components and processing may be implemented by one or more dedicated computers including a combination of one or more memories and one or more processors programmed to perform one or a plurality of functions and another one or more processors including one or more hardware logic circuits.

Moreover, the computer program may be stored, as instructions to be performed by a computer, in a computer-readable non-transitory tangible storage medium. That is to say, the above functional components and processing may be represented as a computer program containing a procedure to implement the above functional configurations and processing or a non-transitory tangible storage medium storing the computer program.

The present disclosure is not limited to the specific functions and operation modes described in the above embodiment. For example, the segment Sg and the segment information may be generated, that is, calculated, by another device outside the object detection device 15. The other device may be, for example, a sensor ECU incorporated in the ranging sensor 11. That is to say, the segment information acquisition unit 503 may acquire, that is, receive, the segment information from the other device. In this case, the detection information acquisition unit 502 and the segment information acquisition unit 503 may be evaluated as substantially the same function.

Needless to say, the elements constituting the above embodiment are not necessarily essential, unless explicitly stated otherwise, considered to be obviously essential in principle, or the like. Moreover, in a case where numerical values such as the number of components, numerical values, quantities, and ranges are referred to, the present disclosure is not limited by these specific numbers, unless they are explicitly stated otherwise, the present disclosure is obviously limited by the specific numbers in principle, or the like. Likewise, in a case where shapes, directions, position relationships, and the like of the components are referred to, the present disclosure is not limited by the shapes, directions, position relationships, and the like, unless they are explicitly stated otherwise or the present disclosure is limited by the specific shapes, directions, position relationships, and the like in principle, or the like.

Similar expressions such as "acquisition", "calculation", "estimation", "detecting", and "detection" are mutually replaceable, if necessary, as long as no technical inconsistency arises. Moreover, the expressions "exceeding a threshold" and "being equal to or greater than a threshold" are mutually replaceable, if necessary, as long as no technical inconsistency arises. The same applies to the expressions "being less than a threshold" and "equal to or less than a threshold."

The modification examples are also not limited to the above examples. For example, all or part of one of the plurality of modification examples may be combined with all or part of another one, as long as no technical inconsistency arises. Further, all or part of the above specific example(s) may be combined with all or part of the above modification example(s), as long as no technical inconsistency arises.

### Points of Disclosure

As can be seen from the above, the present disclosure includes at least the following points as obvious from the descriptions on the configurations and the operations according to the embodiment and the modification examples.

### Point 1-1

An object detection device (15) detecting an object behind a host vehicle (1), the object detection device including:

at least one of (i) a circuit and (ii) a processor with a memory storing computer program code executable by the processor, the at least one of the circuit and the processor configured to implement:

a segment information acquisition unit (503) configured to acquire segment information, the segment information being information regarding a generation result of a segment (Sg), the segment being generated based on detection information from a ranging sensor (11), the segment forming a region corresponding to a candidate for a detection result of the object; and

a segment determination unit (504) configured to perform a towing object determination based on the segment information, the towing object determination being a determination of whether the segment corresponds to a towed object (2) for the host vehicle, wherein

the segment determination unit is configured to perform the towing object determination based on relative positions of a first reference point for determination (P1) and a second reference point for determination (P2) relative to the host vehicle, the first reference point for determination being within the region, the second reference point for determination being at a position in or on the region that is different from the first reference point for determination.

### Point 1-2

The object detection device according to Point 1-1, in which

the region is a rectangle,

the first reference point for determination is a center point of the rectangle, and

the second reference point for determination is a midpoint of a closest edge of the rectangle to the host vehicle.

### Point 1-3

The object detection device according to Point 1-1 or 1-2, in which

the segment determination unit is configured to perform the towing object determination in accordance with whether the first reference point for determination or the second reference point for determination is within a predetermined region (Rt).

### Point 1-4

The object detection device according to Point 1-3, in which

the segment determination unit is configured to:

cause a towing determination to be on in response to the first reference point for determination or the second reference point for determination being within the predetermined region;

accumulate, as a count value, a period of time during which the towing determination is on, or the number of times the towing determination is on;

in a case where the count value is less than a predetermined condition switching threshold, determine that the segment corresponds to the towed object in response to a count condition and an initial position matching condition both being satisfied, the count condition being that the count value is equal to or greater than a predetermined towing determination threshold, the initial position matching condition being that a position of each of the first reference point for determination and the second reference point for determination at a time when the first reference point for determination and the second reference point for determination are initially acquired matches a predetermined initial position condition; and

in a case where the count value is equal to or greater than the condition switching threshold, determine that the segment corresponds to the towed object even though, out of the count condition and the initial position matching condition, only the count condition is satisfied.

### Point 1-5

The object detection device according to Point 1-4, in which

the segment determination unit is configured to prohibit decrementing the count value in response to a driving state of the host vehicle satisfying a predetermined decrement prohibition condition, even though the towing determination is off, and

the decrement prohibition condition includes the host vehicle being stopped or traveling on a curve.

### Point 1-6

The object detection device according to Point 1-1, in which the region is a polygon.

### Point 2-1

An object detection method of detecting an object behind a host vehicle (1), the method including:

acquiring segment information, the segment information being information regarding a generation result of a segment (Sg), the segment being generated based on detection information from a ranging sensor (11), the segment forming a region corresponding to a candidate for a detection result of the object; and

performing a determination of whether the segment corresponds to a towed object (2) for the host vehicle based on the segment information,

the determination being based on relative positions of a first reference point for determination (P1) and a second reference point for determination (P2) relative to the host vehicle, the first reference point for determination being within the region, the second reference point for determination being at a position in or on the region that is different from the first reference point for determination.

### Point 2-2

The object detection method according to Point 2-1, in which

the region is a rectangle,

the first reference point for determination is a center point of the rectangle, and

the second reference point for determination is a midpoint of a closest edge of the rectangle to the host vehicle.

### Point 2-3

The object detection method according to Point 2-1 or 2-2, in which

the segment determination unit is configured to perform the towing object determination in accordance with whether the first reference point for determination or the second reference point for determination is within a predetermined region (Rt).

### Point 2-4

The object detection method according to Point 2-3, in which

the segment determination unit is configured to:

cause a towing determination to be on in response to the first reference point for determination or the second reference point for determination being within the predetermined region;

accumulate, as a count value, a period of time during which the towing determination is on, or the number of times the towing determination is on;

in a case where the count value is less than a predetermined condition switching threshold, determine that the segment corresponds to the towed object in response to a count condition and an initial position matching condition both being satisfied, the count condition being that the count value is equal to or greater than a predetermined towing determination threshold, the initial position matching condition being that a position of each of the first reference point for determination and the second reference point for determination at a time when the first reference point for determination and the second reference point for determination are initially acquired matches a predetermined initial position condition; and

in a case where the count value is equal to or greater than the condition switching threshold, determine that the segment corresponds to the towed object even though, out of the count condition and the initial position matching condition, only the count condition is satisfied.

### Point 2-5

The object detection method according to Point 2-4, in which

the segment determination unit is configured to prohibit decrementing the count value in response to a driving state of the host vehicle satisfying a predetermined decrement prohibition condition, even though the towing determination is off, and

the decrement prohibition condition includes the host vehicle being stopped or traveling on a curve.

### Point 2-6

The object detection device according to Point 2-1, in which the region is a polygon.

### Point 3-1

A non-transitory computer-readable storage medium storing instructions that, when executed by an object detection device (15) configured to detect an object behind a host vehicle, cause the object detection device to perform processing comprising:

acquiring segment information, the segment information being information regarding a generation result of a segment (Sg), the segment being generated based on detection information from a ranging sensor (11), the segment forming a region corresponding to a candidate for a detection result of the object; and

performing a determination of whether the segment corresponds to a towed object (2) for the host vehicle based on the segment information,

the determination being based on relative positions of a first reference point for determination (P1) and a second reference point for determination (P2) relative to the host vehicle, the first reference point for determination being within the region, the second reference point for determination being at a position in or on the region that is different from the first reference point for determination.

### Point 3-2

The recording medium according to Point 3-1, in which

the region is a rectangle,

the first reference point for determination is a center point of the rectangle, and

the second reference point for determination is a midpoint of a closest edge of the rectangle to the host vehicle.

### Point 3-3

The recording medium according to Point 3-1 or 3-2, in which

the segment determination unit is configured to perform the towing object determination in accordance with whether the first reference point for determination or the second reference point for determination is within a predetermined region (Rt).

### Point 3-4

The recording medium according to Point 3-3, in which

the segment determination unit is configured to:

cause a towing determination to be on in response to the first reference point for determination or the second reference point for determination being within the predetermined region;

accumulate, as a count value, a period of time during which the towing determination is on, or the number of times the towing determination is on;

in a case where the count value is less than a predetermined condition switching threshold, determine that the segment corresponds to the towed object in response to a count condition and an initial position matching condition both being satisfied, the count condition being that the count value is equal to or greater than a predetermined towing determination threshold, the initial position matching condition being that a position of each of the first reference point for determination and the second reference point for determination at a time when the first reference point for determination and the second reference point for determination are initially acquired matches a predetermined initial position condition; and

in a case where the count value is equal to or greater than the condition switching threshold, determine that the segment corresponds to the towed object even though, out of the count condition and the initial position matching condition, only the count condition is satisfied.

### Point 3-5

The recording medium according to Point 3-4, in which

the segment determination unit is configured to prohibit decrementing the count value in response to a driving state of the host vehicle satisfying a predetermined decrement prohibition condition, even though the towing determination is off, and

the decrement prohibition condition includes the host vehicle being stopped or traveling on a curve.

### Point 3-6

The object detection device according to Point 3-1, in which the region is a polygon.

What is claimed is:

1. An object detection device detecting an object behind a host vehicle, the object detection device comprising:
at least one of (i) a circuit and (ii) a processor with a memory storing computer program code executable by the processor, the at least one of the circuit and the processor configured to implement:
a segment information acquisition unit configured to acquire segment information, the segment information being information regarding a generation result of a segment, the segment being generated based on detection information from a ranging sensor, the segment forming a region corresponding to a candidate for a detection result of the object; and
a segment determination unit configured to perform a towing object determination based on the segment information, the towing object determination being a determination of whether the segment corresponds to a towed object for the host vehicle, wherein
the segment determination unit is configured to perform the towing object determination based on relative positions of a first reference point for determination and a second reference point for determination relative to the host vehicle, the first reference point for determination being within the region, the second reference point for determination being at a position in or on the region that is different from the first reference point for determination.

2. The object detection device according to claim 1, wherein
the region is a rectangle,
the first reference point for determination is a center point of the rectangle, and
the second reference point for determination is a midpoint of a closest edge of the rectangle to the host vehicle.

3. The object detection device according to claim 1, wherein
the segment determination unit is configured to perform the towing object determination in accordance with whether the first reference point for determination or the second reference point for determination is within a predetermined region.

4. The object detection device according to claim 3, wherein
the segment determination unit is configured to:
cause a towing determination to be on in response to the first reference point for determination or the second reference point for determination being within the predetermined region;
accumulate, as a count value, a period of time during which the towing determination is on, or the number of times the towing determination is on;
in a case where the count value is less than a predetermined condition switching threshold, determine that the segment corresponds to the towed object in response to a count condition and an initial position matching condition both being satisfied, the count condition being that the count value is equal to or greater than a predetermined towing determination threshold, the initial position matching condition being that a position of each of the first reference point for determination and the second reference point for determination at a time when the first reference point for determination and the second reference point for determination are initially acquired matches a predetermined initial position condition; and
in a case where the count value is equal to or greater than the condition switching threshold, determine that the segment corresponds to the towed object even though, out of the count condition and the initial position matching condition, only the count condition is satisfied.

5. The object detection device according to claim 4, wherein
the segment determination unit is configured to prohibit decrementing the count value in response to a driving state of the host vehicle satisfying a predetermined decrement prohibition condition, even though the towing determination is off, and
the decrement prohibition condition includes the host vehicle being stopped or traveling on a curve.

6. The object detection device according to claim 1, wherein the region is a polygon.

7. An object detection method of detecting an object behind a host vehicle, the method comprising:
acquiring segment information, the segment information being information regarding a generation result of a segment, the segment being generated based on detection information from a ranging sensor, the segment forming a region corresponding to a candidate for a detection result of the object; and
performing a determination of whether the segment corresponds to a towed object for the host vehicle based on the segment information,
the determination being based on relative positions of a first reference point for determination and a second reference point for determination relative to the host vehicle, the first reference point for determination being within the region, the second reference point for determination being at a position in or on the region that is different from the first reference point for determination.

8. A non-transitory computer-readable storage medium storing instructions that, when executed by an object detection device configured to detect an object behind a host vehicle, cause the object detection device to perform processing comprising:
acquiring segment information, the segment information being information regarding a generation result of a segment, the segment being generated based on detection information from a ranging sensor, the segment forming a region corresponding to a candidate for a detection result of the object; and
performing a determination of whether the segment corresponds to a towed object for the host vehicle based on the segment information,
the determination being based on relative positions of a first reference point for determination and a second reference point for determination relative to the host vehicle, the first reference point for determination being within the region, the second reference point for determination being at a position in or on the region that is different from the first reference point for determination.
